(19) United States
(12) Patent Application Publication
(10) Pub. No.: US 2026/0079272 A1
(43) Pub. Date: Mar. 19, 2026

(54) EXTREME ULTRAVIOLET OR SOFT X-RAY RADIATION BEAM PROFILER

(71) Applicant: ACADEMIA SINICA, Taipei (TW)

(72) Inventors: Huan-Cheng CHANG, Taipei City (TW); Teng-I YANG, Tainan City (TW); Yuen Yung HUI, Taipei City (TW); Chen-Yu HO, Taichung City (TW)

(21) Appl. No.: 18/884,500

(22) Filed: Sep. 13, 2024

(51) Int. Cl. G01T 1/29; C01B 32/25; C09K 11/65

(52) U.S. Cl. CPC G01T 1/2914; C01B 32/25; C09K 11/65; C01P 2002/54; C01P 2004/03; C01P 2004/62; C01P 2004/64; C01P 2006/60

(57) ABSTRACT

The present disclosure provides a beam profiler for extreme ultraviolet (EUV) or soft X-ray (SXR) radiation, comprising a scintillator and an imaging system configured to capture a fluorescence image generated by the scintillator. The scintillator includes a substrate and a scintillator layer disposed over the substrate. The scintillator layer comprises one or more fluorescent nitrogen-vacancy diamonds and has a density of about 1 to 3.5 g/cm³. This innovative design enables precise measurement and profiling of EUV or SXR radiation, offering high sensitivity and spatial resolution for various applications in scientific research and industrial processes.

### FIELD OF INVENTION

The present disclosure relates to the field of electromagnetic radiation profiling, specifically focusing on extreme ultraviolet (EUV) or soft X-ray (SXR) radiation. More particularly, the present disclosure pertains to methods and apparatuses for characterizing the beam properties of EUV and SXR radiation.

### BACKGROUND OF INVENTION

EUV and SXR radiations are defined as electromagnetic radiations with wavelengths ranging from 10 to 120 nm (about 10 to 124 eV) and 0.1 to 10 nm (about 124 to 12.4 keV), respectively. Recent advancements in the fabrication of nanoelectronic chips have led to a surge in interest in EUV, particularly the use of 13.5 nm radiation in advanced photolithography equipment. This interest is further fueled by ongoing proposals to use SXR as the light source for next-generation photolithography, a concept that has been under consideration for nearly 50 years.

Despite these advancements, there remains a significant challenge in effectively characterizing the beam properties of EUV and SXR radiations due to their strong absorption by air and the necessity for detection in a vacuum.

### SUMMARY OF INVENTION

The present disclosure relates to a beam profiler for EUV or SXR radiation, designed to provide high sensitivity and spatial resolution for various applications in scientific research and industrial processes.

In one aspect, the present disclosure provides a beam profiler comprising a scintillator and an imaging system configured to capture a fluorescence image generated by the scintillator. The scintillator includes a substrate and a scintillator layer disposed over the substrate. The scintillator layer comprises one or more fluorescent nitrogen-vacancy diamonds and has a density of about 1 to 3.5 g/cm³.

In another aspect, the present disclosure provides a beam profiler comprising a scintillator and an imaging system contacting the scintillator. The scintillator includes a fiber optic plate, an electrically conductive layer over the fiber optic plate, and a scintillator layer over the electrically conductive layer. The scintillator layer comprises one or more fluorescent nitrogen-vacancy diamonds and has a length of about 1 to 100 mm in the direction substantially parallel to an interface between the electrically conductive layer and the fiber optic plate.

In yet another aspect, the present disclosure provides a scintillator comprising a substrate and a scintillator layer disposed over the substrate. The scintillator layer comprises one or more fluorescent nitrogen-vacancy diamonds and has a density of about 1 to 3.5 g/cm³.

In a further aspect, the present disclosure provides a method for forming a scintillator. The method comprises providing a substrate, dispersing fluorescent nitrogen-vacancy diamond particles in a solvent to form a dispersion, producing charged droplets comprising the fluorescent nitrogen-vacancy diamond particles from the dispersion, and depositing the charged droplets over the substrate.

The beam profiler described in the present disclosure offers several significant advantages for the characterization and monitoring of EUV or SXR radiation. By employing a scintillator layer comprising fluorescent nitrogen-vacancy diamonds (FNVDs), the beam profiler achieves high UV-to-visible conversion efficiency, short fluorescence decay time, and low light afterglow. These characteristics are essential for effective EUV or SXR detection, providing high spatial resolution and excellent image contrast.

The innovative design of the scintillator layer described in the present disclosure, with its optimized thickness, surface roughness average (Rₐ), and average nitrogen-vacancy (NV) density, ensures superior sensitivity and luminescent intensity. The use of FNVDs with NV centers enhances photostability and minimizes light afterglow, resulting in a near-constant emission profile over a broad wavelength range. This makes the beam profiler highly suitable for high-performance detection of vacuum ultraviolet, EUV, and X-rays.

Additionally, the beam profiler demonstrates high material efficiency and controlled deposition through the electrospray deposition process, ensuring uniform thickness and structural uniformity of the scintillator layer. The versatility of the method allows for application to a wide range of substrates, including fiber optic plates (FOPs), making it suitable for various applications and substrate types.

The beam profiler exhibits a linear response over a wide photon flux range, high spatial resolution, and a high signal-to-noise ratio, ensuring precise beam diagnostics and monitoring. The compact and cost-effective design, combined with excellent photostability and durability, makes the beam profiler an ideal tool for advanced imaging and detection applications in scientific research and industrial processes involving EUV and SXR radiations.

### BRIEF DESCRIPTION OF DRAWINGS

Aspects of the present disclosure are readily understood from the following detailed description when read with the accompanying figures. It should be noted that various features may not be drawn to scale. In fact, the dimensions of the various features may be arbitrarily increased or reduced for clarity of discussion.

FIG. 1(a) illustrates a cross-sectional view of a scintillator 10 according to an embodiment of the present disclosure.

FIG. 1(b) illustrates a cross-sectional view of a scintillator 11 according to an embodiment of the present disclosure.

FIG. 2 shows an exemplified setup for forming the scintillator 10, 11.

FIG. 3(a) illustrates a cross-sectional view of a beam profiler 20 according to an embodiment of the present disclosure.

FIG. 3(b) illustrates a cross-sectional view of a beam profiler 21 according to an embodiment of the present disclosure.

FIG. 4(a) shows a plan view scanning electron microscopy (SEM) image of a FNVD layer deposited on the ITO-coated glass substrate according to an embodiment of the present disclosure.

FIG. 4(b) shows a cross-sectional view SEM image of a FNVD layer deposited on the ITO-coated glass substrate according to an embodiment of the present disclosure.

FIG. 5(a) shows the fluorescence image and an intensity line profile in the vertical direction of the 50 nm radiation in the BL03A1 bending-magnet beamline.

FIG. 5(b) shows the fluorescence image and an intensity line profile in the vertical direction of the 50 nm radiation in the BL21B2 undulator beamline.

FIG. 6 shows the variation of the beam shape with the photon energy of the synchrotron radiations over 300 to 1400 eV. Numbers in parentheses are exposure times in the units of ms.

FIG. 7 shows the photostability test result of the beam profiler according to an embodiment of the present disclosure using 13.5 nm radiation from the BL08B beamline at an intensity of 24 μW/mm² for more than 6 hours. The images in FIG. 7 reveal the beam at the beginning (left) and end (right) of the measurements.

FIG. 8 shows the light yields of the scintillator according to an embodiment of the present disclosure over the energy range of 80-1200 eV.

### DETAILED DESCRIPTION OF THE INVENTION

Common reference numerals are used throughout the drawings and the detailed description to indicate the same or similar components. Embodiments of the present disclosure will be readily understood from the following detailed description taken in conjunction with the accompanying drawings.

Spatial descriptions, such as “above,” “below,” “up,” “left,” “right,” “down,” “top,” “bottom,” “vertical,” “horizontal,” “side,” “higher,” “lower,” “upper,” “over,” “under,” and so forth, are specified with respect to a certain component or group of components, or a certain plane of a component or group of components, for the orientation of the component(s) as shown in the associated figure. It should be understood that the spatial descriptions used herein are for purposes of illustration only, and that practical implementations of the structures described herein can be spatially arranged in any orientation or manner, provided that the merits of embodiments of this disclosure are not deviated from by such arrangement.

In the following description, articles of manufacture, methods for manufacturing the same, and the like are set forth as preferred examples. It will be apparent to those skilled in the art that modifications, including additions and/or substitutions may be made without departing from the scope and spirit of the present disclosure. Specific details may be omitted so as not to obscure the present disclosure; however, the disclosure is written to enable one skilled in the art to practice the teachings herein without undue experimentation.

Characterizing the beam properties of EUV and SXR radiations is essential in EUV lithography, which uses multilayered mirrors (e.g., Mo/Si coating) to guide and focus the radiation (e.g., 13.5 nm) on semiconductor wafers. Any degradation or contamination of the mirrors may cause divergence of the EUV beam and change its spatial intensity distribution at the wafer's position. Constant radiation monitoring to qualify the optical components and determine the beam position and uniformity by EUV imaging is desired.

There are two ways of profiling EUV radiations: direct and indirect. The first (direct) method uses a backside-illuminated charged-coupled device (CCD) or complementary metal-oxide-semiconductor (CMOS) camera to detect the radiations, which create free electrons inside the sensing elements. Although the method is highly sensitive, it is costly and the detector is prone to radiation damage under intense illumination. The second (indirect) method involves using a scintillator to convert EUV photons into visible light, which is subsequently imaged by a standard semiconductor-based camera. Although the indirect detection method has a lower sensitivity than direct detection, it is more versatile and cost-effective.

Detectors, such as Si-based photodiodes or imaging sensors, face limitations due to the shallow penetration depth of EUV in silicon, which is approximately 10 nm at a wavelength of 90 nm. This shallow penetration depth necessitates positioning the photo-sensing region very close to the substrate's surface to achieve high responsivity. At 13.5 nm, although the light penetration depth in Si increases to about 0.7 μm, the detection performance of the semiconductor chips can severely degrade due to irradiation-induced charging in the top oxide layers, such as SiO₂.

Backside-thinned back-illuminated sensors may be sued to address the issue of shallow light penetration depth. However, these sensors are costly to fabricate due to the need to thin the Si substrate to only a few microns. Additionally, EUV and SXR radiations can ablate Si-based semiconductor chips over time, necessitating the use of EUV/SXR-to-visible photon converters to avoid direct exposure of Si chips to ionizing radiations.

Covering sensors with phosphors to convert EUV/SXR radiations to visible light presents an appealing alternative. Desired characteristics of a scintillator for EUV detection include high UV-to-visible conversion efficiency, short fluorescence decay time, low light afterglow (radiation-induced phosphorescence), high spatial resolution, vacuum compatibility, high radiation damage threshold, and good mechanical strength. Sodium salicylate may be used in EUV detection as a scintillator. The material has the advantage of nearly constant response over the 30 to 300 nm wavelength region; however, its photostability is poor, and the sodium salicylate films prepared by spraying the powders on UV/vis windows are highly scattering, making them unsuitable for imaging applications.

In summary, the present disclosure addresses the challenges associated with EUV and SXR radiation profiling by employing advanced photon conversion techniques and deposition methods to produce low-cost, compact, and broadband EUV or SXR beam profiler with excellent photostability, high resolution, and exceptional contrast.

### Definition of Terms

Optically transparent: Refers to a material's ability to transmit visible light with minimal absorption or scattering. Specifically, in the context of the present disclosure, an optically transparent substrate is defined as having a transmittance ≥50%, preferably ≥60%, more preferably ≥70% for visible light within the wavelength range of 400 to 700 nm.

Optically opaque: Refers to a material's ability to absorb or scatter visible light with minimal transmission. Specifically, in the context of the present disclosure, an optically opaque substrate is defined as having a transmittance <50%, preferably ≤40%, more preferably ≤30% for visible light within the wavelength range of 400 to 700 nm.

Electrically conductive substrate/layer or conductive substrate/layer: A substrate/layer is considered electrically conductive if it allows the flow of electric current through it. This type of substrate/layer typically includes materials such as indium tin oxide (ITO), fluorine-doped tin oxide (FTO), aluminum-doped zinc oxide (AZO), gallium-doped zinc oxide (GZO), and graphene. These materials have free electrons or other charge carriers that can move easily under the influence of an electric field, enabling the substrate to conduct electricity effectively.

Electrically insulating substrate/layer or insulating substrate/layer: A substrate/layer is considered electrically insulating if it resists the flow of electric current. This type of substrate typically includes materials such as glass, FOP, quartz, and sapphire. These materials have tightly bound electrons that do not move freely, preventing the passage of electric current and providing electrical isolation between different components.

Mean hydrodynamic diameter: The mean hydrodynamic diameter of FNVD particles refers to the average diameter of a hypothetical solid sphere that exhibits the same hydrodynamic frictional properties as the FNVD particles in a liquid medium. This measurement is typically obtained using dynamic light scattering (DLS) techniques, which account for the influence of a thin electric dipole layer that adheres to the surface of the particles as they move through the liquid.

Polydispersity index (PDI): The polydispersity index is a numerical value that indicates the range of particle size distribution within a sample of FNVD particles. It is calculated as the ratio of the standard deviation of the particle size to the mean particle size. A higher PDI value signifies a broader range of particle sizes and a less uniform particle distribution. This index is typically measured using DLS techniques and is used to assess the behavior and characteristics of FNVD particles.

### Scintillator

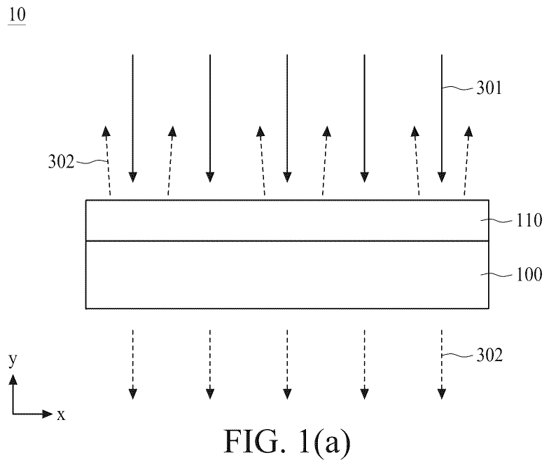

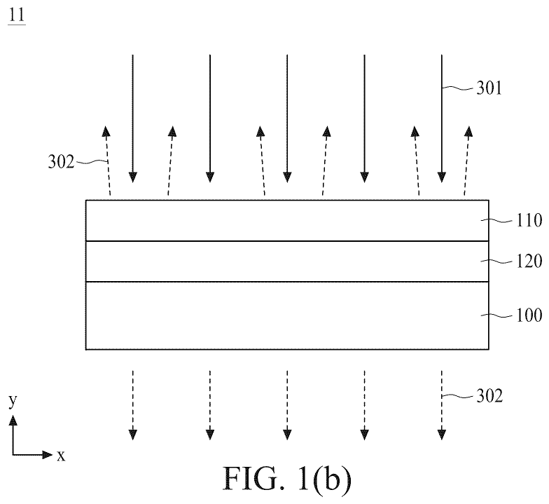

FIG. 1(a) illustrates a cross-sectional view of a scintillator 10 according to an embodiment of the present disclosure. The scintillator 10 comprises a substrate 100 and a scintillator layer 110 disposed over the substrate 100. The scintillator layer may include one or more FNVDs. The scintillator layer may consist of one or more FNVDs. The FNVD may be obtained according to U.S. Pat. No. 11,029,421 B2, the full text of which is incorporated herein by reference. In the text, the direction y may be defined as the thickness direction of the substrate 100. The direction x may be defined as the direction substantially perpendicular to the direction y. The direction x may be defined as the direction substantially parallel to the interface between the scintillator layer 110 and the substrate 100.

The substrate 100 may be optically transparent. The substrate 100 may be optically opaque. The substrate 100 may be electrically conductive. The substrate 100 may be electrically insulating. Suitable electrically conductive optically transparent substrates may include, but are not limited to: ITO, FTO, AZO, GZO, and graphene.

The FNVD may include one or more NV centers. The average density of the NV centers may range from about 0.1 to 1,000 parts per million (ppm). For example, the average NV density may be about 0.1, 0.2, 0.4, 0.5, 0.6, 0.8, 1, 2, 4, 5, 6, 8, 10, 12, 14, 15, 16, 18, 20, 40, 50, 60, 80, 100, 200, 400, 500, 600, 800, or 1,000 ppm. A suitable average NV density range may be formed from any two of the aforementioned values.

The NV centers may substantially consist of neutral NV centers (NV⁰) and may substantially exclude negative NV centers (NV⁻). For definitions of neutral NV⁰ and negative NV⁻ centers, please refer to U.S. Pat. No. 11,029,421 B2. The present disclosure has found that the fluorescence features of neutral NV⁰ centers strongly overlap with the absorption bands (peaking at 550 nm and FWHM around 100 nm) of negative NV centers, whose zero-phonon line is located at 638 nm. Consequently, if the density of negative NV centers is high, self-absorption of luminescence occurs, which may affect the overall performance of the scintillator layer 110.

In some embodiments, the average density of neutral NV⁰ centers may range from about 0.1 to 1,000 ppm. For example, the average density of neutral NV⁰ centers may be about 0.1, 0.2, 0.4, 0.5, 0.6, 0.8, 1, 2, 4, 5, 6, 8, 10, 12, 14, 15, 16, 18, 20, 40, 50, 60, 80, 100, 200, 400, 500, 600, 800, or 1,000 ppm. A suitable average density range of neutral NV⁰ centers may be formed from any two of the aforementioned values.

Radiation 301 may be incident on the scintillator layer 110 along the direction y. The FNVD may convert radiation 301 into radiation 302. The FNVD may absorb radiation 301. The FNVD may be excited by radiation 301. The FNVD may emit radiation 302. Radiation 301 may have an energy ranging from about 10 to 1500 electron volts (eV). For example, the energy of radiation 301 may be about 10, 20, 30, 40, 50, 60, 70, 80, 90, 100, 120, 140, 150, 160, 180, 200, 300, 400, 500, 600, 700, 800, 900, 1,000, 1,100, 1,200, 1,300, 1,400, or 1,500 eV.

A suitable range may be formed from any two of the aforementioned values. Radiation 301 may have a wavelength ranging from about 0.8 to 120 nanometers (nm). For example, the wavelength of radiation 301 may be about 0.8, 0.9, 1, 2, 3, 4, 5, 6, 7, 8, 9, 10, 11, 12, 13, 14, 15, 16, 18, 20, 30, 40, 50, 60, 70, 80, 90, 100, 110, or 120 nm. A suitable range may be formed from any two of the aforementioned values. Radiation 302 may have an energy ranging from about 1.7 to 3.1 eV. For example, the energy of radiation 302 may be about 1.7, 1.8, 1.9, 2, 2.1, 2.2, 2.3, 2.4, 2.5, 2.6, 2.7, 2.8, 2.9, 3, or 3.1 eV. A suitable range may be formed from any two of the aforementioned values. Radiation 302 may have a wavelength ranging from about 400 to 700 nm. For example, the wavelength of radiation 302 may be about 400, 425, 450, 475, 500, 525, 550, 575, 600, 625, 650, 675, or 700 nm. A suitable range may be formed from any two of the aforementioned values.

The scintillator layer 110 may have a light yield of greater than or equal to 10 photons/keV at the energy of radiation 301 ranging from about 10 to 1500 eV. The light yield is defined as the number of photons of radiation 302 generated per unit of energy deposited in the scintillator layer 110 by an ionizing photon of radiation 301. It is related to the quantum yield, defined as the number of emitted photons versus the number of absorbed photons, by the equation:

$$Light yield = Quantum yield / E$$

where E is the energy of each ionizing photon of radiation 301. For example, the light yield at the energy of radiation 301 ranging from about 10 to 1500 eV may be about 10, 15, 20, 25, 30, 35, 40, 45, 50, 55, 60, 65, 70, 80, 90, 100, 120, 140, 150, 160, 180, or 200 photons/keV. The light yield at the energy of radiation 301 of about 200 eV may be about 20, 25, 30, 35, 40, 45, 50, 55, 60, 65, 70, 80, 90, 100, 120, 140, 150, 160, 180, or 200 photons/keV. The light yield at the energy of radiation 301 of about 400 eV may be about 10, 15, 20, 25, 30, 35, 40, 45, 50, 55, 60, 65, 70, 80, 90, 100, 120, 140, 150, 160, 180, or 200 photons/keV. The light yield at the energy of radiation 301 of about 600 eV may be about 20, 25, 30, 35, 40, 45, 50, 55, 60, 65, 70, 80, 90, 100, 120, 140, 150, 160, 180, or 200 photons/keV. The light yield at the energy of radiation 301 of about 800 eV may be about 30, 35, 40, 45, 50, 55, 60, 65, 70, 80, 90, 100, 120, 140, 150, 160, 180, or 200 photons/keV. The light yield at the energy of radiation 301 of about 1000 eV may be about 35, 40, 45, 50, 55, 60, 65, 70, 80, 90, 100, 120, 140, 150, 160, 180, or 200 photons/keV. The light yield at the energy of radiation 301 of about 1200 eV may be about 45, 50, 55, 60, 65, 70, 80, 90, 100, 120, 140, 150, 160, 180, or 200 photons/keV. The lower limit of the light yield may be any of the aforementioned values. A suitable range of the light yield may be formed from any two of the aforementioned values.

If the substrate 100 is optically transparent, the radiation 302 may penetrate through the substrate 100 substantially along the direction y. If the substrate 100 is optically transparent, the radiation 302 may be back-scattered substantially along the direction y. If the substrate 100 is optically transparent, the scintillator 10 may be operated in transmission mode. If the substrate 100 is optically opaque, the radiation 302 may be back-scattered substantially along the direction y. If the substrate 100 is optically opaque, the scintillator 10 may be operated in reflective mode. For example, if the scintillator 10 is in reflective mode, the scintillator 10 may be used as a viewing plate for EUV or SXR beams.

The scintillator layer 110 may have a thickness ranging from about 0.1 to 500 μm. For example, the thickness of the scintillator layer 110 may be about 0.1, 0.2, 0.4, 0.5, 0.6, 0.8, 1, 2, 5, 6, 8, 10, 20, 40, 50, 60, 80, 100, 200, 300, 400, or 500 μm. A suitable thickness range may be formed from any two of the aforementioned values. The scintillator layer 110 may have an average Rₐ of less than about 1,000 nm. For example, the average Rₐ of the scintillator layer 110 may be about 10, 20, 40, 50, 60, 80, 100, 120, 140, 150, 160, 180, 200, 250, 300, 400, 500, 600, 800, or 1,000 nm. The upper limit of the range of average Rₐ may be any of the aforementioned values. A suitable range of Rₐ may be formed from any two of the aforementioned values.

In some embodiments, the inventor has unexpectedly discovered that the interplay among the energy of radiation 301 and the thickness of the scintillator layer 110 significantly influences the spatial resolution, sensitivity, and luminescent intensity of the scintillator. Specifically, higher energy radiation typically necessitates thicker layers to maintain optimal luminescent intensity, which can negatively impact spatial resolution. Conversely, lower energy radiation benefits from thinner layers, enhancing spatial resolution but potentially reducing sensitivity and luminescent intensity.

Selecting an appropriate combination of thickness, surface roughness (Rₐ), and average NV/NV⁰ density for the scintillator layer requires extensive and innovative research efforts due to the complex interdependencies among these factors. Thinner layers with low Ra and high average NV density generally provide superior spatial resolution by minimizing light scattering. However, sensitivity is influenced by the thickness of the scintillator layer, as thicker layers can absorb more radiation and generate more luminescent photons. Balancing these opposing effects necessitates a deep understanding of material properties, advanced fabrication methods, and innovative process control strategies. Through extensive and innovative research efforts, the present disclosure provides an optimized design for the scintillator layer 110, with a parameter combination of a thickness ranging from about 0.1 to 500 μm, an average Rₐ of less than about 1,000 nm, and an average density of the NV centers, particularly the neutral NV⁰ centers, ranging from about 0.1 to 1,000 ppm.

The scintillator layer 110 may have a density of about 1 to 3.5 g/cm³. For example, the density of the scintillator layer 110 may be about 1, 1.1, 1.2, 1.3, 1.4, 1.5, 1.6, 1.7, 1.8, 1.9, 2, 2.1, 2.2, 2.3, 2.4, 2.5, 2.6, 2.7, 2.8, 2.9, 3, 3.1, 3.2, 3.3, 3.4, or 3.5 g/cm³. A suitable range of density of the scintillator layer 110 may be formed from any two of the aforementioned values.

The scintillator layer 110 may be polycrystalline. The scintillator layer 110 may have a length of about 1 to 100 mm substantially along the direction x. For example, the length may be about 1, 2, 4, 5, 6, 8, 10, 20, 30, 40, 50, 60, 70, 80, 90 or 100 mm. A suitable range of the thickness may be formed from any two of the aforementioned values.

The scintillator layer 110 may exhibit a fluorescence intensity decrease of less than 10% after six hours of exposure to 13.5 nm radiation at an intensity of 24 μW/mm². For example, the fluorescence intensity decrease may be about 0.1, 0.5, 1, 1.5, 2, 2.5, 3, 3.5, 4, 4.5, 5, 6, 7, 8, 9, or 10%. The upper limit of the fluorescence intensity decrease may be any of the aforementioned values. A suitable range of the fluorescence intensity decrease may be formed from any two of the aforementioned values.

The scintillator layer 110 may have a fluorescence decay time greater than or equal to about 10 ns, revealing a significant afterglow. For example, the fluorescence decay time may be about 10, 20, 30, 40, 50, 60, 70, 80, 90, 100, 120, 140, 150, 160, 180, or 200 ns. The lower limit of the fluorescence decay time may be any of the aforementioned values. A suitable range of the fluorescence decay time may be formed from any two of the aforementioned values.

FIG. 1(b) illustrates a cross-sectional view of a scintillator 11 according to an embodiment of the present disclosure. The scintillator 11 is substantially the same as the scintillator 10, except that an intermediate layer 120 is disposed between the scintillator layer 110 and the substrate 100 substantially along the direction y. The layer 120 may be electrically conductive. The layer 120 may be optically transparent. The layer 120 may be optically opaque. The scintillator layer 110 may be disposed over the layer 120. The scintillator layer 110 may contact the layer 120. The layer 120 may be disposed over the substrate 100. The layer 120 may contact the substrate 100. If the layer 120 or the substrate 100 is optically opaque, the scintillator 11 may be operated in reflective mode. If the layer 120 and the substrate 100 are both optically transparent, the scintillator 11 may be operated in transmission mode.

Suitable materials for the layer 120 may include, but are not limited to, ITO, FTO, AZO, GZO, and graphene. Other optically transparent conductive layers that are generally formed on an insulating transparent substrate may also be used, such as silver nanowires, conductive polymers (e.g., PEDOT:PSS), and thin metal films (e.g., gold or silver).

The layer 120 may have a thickness ranging from 50 to 500 nm. For example, the thickness of layer 120 may be 50, 60, 80, 100, 120, 140, 150, 160, 180, 200, 250, 300, 350, 400, 450, or 500 nm. A suitable range of the thickness of layer 120 may be formed from any two of the aforementioned values.

In the scintillator 11, the substrate 100 may be electrically insulating. The materials of the substrate 100 used in the scintillator 11 are not particularly limited. For example, the materials of the substrate 100 may include glass, FOP, quartz, sapphire, or other electrically insulating optically transparent substrates that are generally used in scintillators.

The FOP may include one or more optical fibers. Each optical fiber may have a first end at a first surface of the substrate 100 and a second end at a second surface of the substrate 100, opposite to the first surface. The optical fibers may extend along the direction y. The layer 120 may be disposed over the first end of the optical fibers. The layer 120 may contact the optical fibers. The scintillator layer 110 may be disposed over the first end of the optical fibers. The scintillator layer 110 may not contact the first end of the optical fibers. The FOP may have a numerical aperture of about 0.5 to 2. For example, the numerical aperture of FOP may be about 0.5, 0.6, 0.8, 1, 1.2, 1.4, 1.5, 1.6, 1.8, or 2. A suitable range of the numerical aperture of FOP may be formed from any two of the aforementioned values. The FOP may have a resolving power of about 2 to 10 μm. For example, the resolving power of FOP may be about 2, 3, 4, 5, 6, 7, 8, 9, or 10 μm. A suitable range of the resolving power of FOP may be formed from any two of the aforementioned values.

The scintillator 10, 11 according to the present disclosure offers several significant advantages. The FNVD used in scintillator 10, 11 contains NV centers, which are optically active defects that provide exceptional photostability and negligible light afterglow. This results in a near-constant emission profile from NV₀ centers over the 550-800 nm range, making FNVD highly suitable for high-performance detection of vacuum ultraviolet, EUV, and X-rays.

Compared to organic phosphors such as sodium salicylate, which degrade rapidly under continuous EUV or SXR excitation, the scintillator 10, 11 significantly improves scintillator durability and sensing performance. The scintillator 10, 11 demonstrates high photostability, with no significant decrease in fluorescence intensity under continuous illumination by 1×10¹⁰ photons per second. This ensures reliable and consistent performance over extended periods, making the scintillator 10, 11 an ideal choice for applications requiring long-term stability.

Additionally, the scintillator 10, 11 exhibits a high UV-to-visible conversion efficiency, short fluorescence decay time, and low light afterglow, which are essential characteristics for effective EUV or SXR detection. The uniform thickness and structural uniformity of the scintillator layer 110 further enhance the performance of the scintillator 10, 11, providing high spatial resolution and excellent image contrast.

### Method for Forming Scintillator

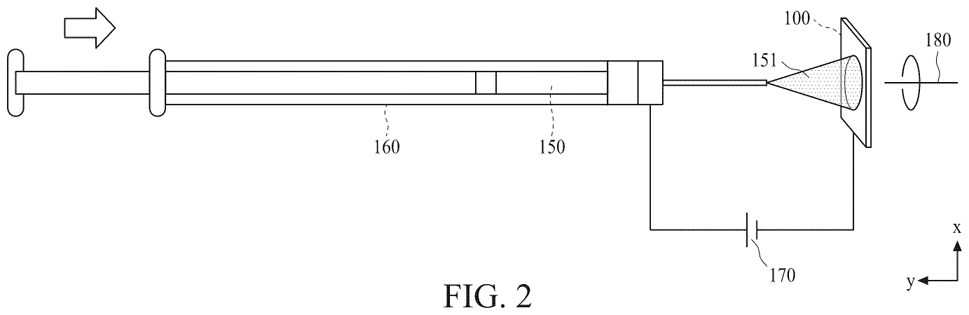

The present disclosure further provides a method for forming the scintillator 10, 11. FIG. 2 shows an exemplified setup for forming the scintillator 10, 11. The method comprises:
providing the substrate 100;
dispersing FNVD particles in a solvent to form a dispersion 150;
producing charged droplets 151 comprising the FNVD particles from the dispersion 150; and
depositing the charged droplets 151 over the substrate 100.

The method may further comprise providing the layer 120 over the substrate 100. The layer 120 may be provided on the substrate 100 using known thin film deposition techniques, such as chemical vapor deposition (CVD), physical vapor deposition (PVD), or magnetron sputtering. The method may further comprise depositing the charged droplets 151 over the layer 120. The method may further comprise cleaning the surface of the substrate 100 or layer 120 using oxygen plasma. The time period for depositing the charged droplets 151 over the substrate 100 or layer 120 may be controlled to achieve a desired thickness of the scintillator layer 110. The substrate 100 may rotate along a rotation axis 180. The rotation axis 180 may be substantially perpendicular to the surface of substrate 100 for receiving the charged droplets 151. The rotation axis 180 may be substantially parallel to the direction y.

The deposition of charged droplets 151 may be an electrospray deposition process. Specifically, the method may further comprise providing the dispersion 150 in an injector 160. For example, the injector 160 may be a syringe, a capillary tube, or a microfluidic device. An electrical potential or electrical field 170 may be applied between the injector 160 and the substrate 110. The injector 160 may be positively biased or at high potential energy. The substrate 110 may be negatively biased or at low potential energy. The electrical field 170 may be about +1 to +10 kV/cm. For example, the electrical field 170 may be about 1, 2, 3, 4, 5, 6, 7, 8, 9, or 10 kV/cm. A suitable range of the electrical field 170 may be formed from any two of the aforementioned values. The injection rate of the dispersion 150 from the injector 160 may be about 100 to 300 μL/h. For example, the injection rate may be about 100, 120, 140, 150, 160, 180, 200, 220, 240, 250, 260, 280, or 300 μL/h. A suitable range of the injection rate may be formed from any two of the aforementioned values. In an embodiment, the injection rate of a syringe as the injector 160 may be controlled by using a syringe pump.

Comparing known techniques for producing a film from diamond particles, such as spin coating or sedimentation coatings, it has been surprisingly found that the electrospray deposition process is a unique method capable of forming the scintillator layer 110 with a density of about 1 to 3.5 g/cm³. This is due to the unique ability of the electrospray deposition process to generate a fine mist of charged droplets, which allows for precise control over the deposition parameters. The high electric field applied during the process ensures that the FNVD particles are well-dispersed and uniformly deposited onto the substrate, resulting in a dense and homogeneous scintillator layer.

In contrast, other techniques for producing a film from diamond particles often result in significant material loss and non-uniform thickness, leading to lower density and poor structural uniformity. The electrospray deposition process minimizes waste and maximizes efficiency by ensuring that the FNVD particles are deposited with high precision and consistency. The electrospray deposition process also allows for the formation of thin layers with desired NV density and controlled thickness and surface roughness (Rₐ), which are essential for achieving the desired density and performance characteristics of the scintillator layer 110.

The solvent for dispersing FNVD particles is not particularly limited. For example, the solvent may be a mixture of water and methanol, ethanol, acetone, or dimethylformamide (DMF). The FNVD particles may have a mean hydrodynamic diameter of about 50 to 200 nm. For example, the mean hydrodynamic diameter may be about 50, 60, 70, 80, 90, 100, 120, 140, 150, 160, 180, or 200 nm. A suitable range of the mean hydrodynamic diameter may be formed from any two of the aforementioned values. The FNVD particles may have a PDI of about 0.05 to 0.2. For example, the PDI may be about 0.05, 0.06, 0.08, 0.1, 0.12, 0.14, 0.15, 0.16, 0.18, or 0.2. A suitable range of the PDI may be formed from any two of the aforementioned values.

The method according to the present disclosure offers several advantages over other deposition methods such as spin coating and sedimentation coatings. In particular, the method according to the present disclosure exploits an electric field to generate a fine mist of charged droplets for deposition on a conducting substrate. This method provides several key benefits:

Material Efficiency: Unlike spin coating, which results in significant material loss, the application of an electric field ensures that the FNVD particles to be deposited are well dispersed in the high electric field, minimizing waste and maximizing efficiency.

Controlled Deposition: The deposition thickness and area can be readily controlled by adjusting the spray time and plume size. This allows for precise control over the properties of deposition layers, ensuring uniform thickness and structural uniformity.

Versatility: The method according to the present disclosure can be applied to a wide range of substrates, including insulating substrates like FOPs by first coating them with a thin layer of ITO. This versatility makes it suitable for various applications and substrate types.

High Uniformity: The method according to the present disclosure produces the scintillator layer 110 with a high level of structural uniformity, which is essential for achieving high spatial resolution and excellent image contrast for EUV or SXR beam profiling.

Cost-Effectiveness: The method according to the present disclosure is cost-effective and produces low-cost, compact, and broadband EUV/SXR-responsive beam profilers with excellent photostability, high resolution, and exceptional contrast.

### EUV or SXR Beam Profiler

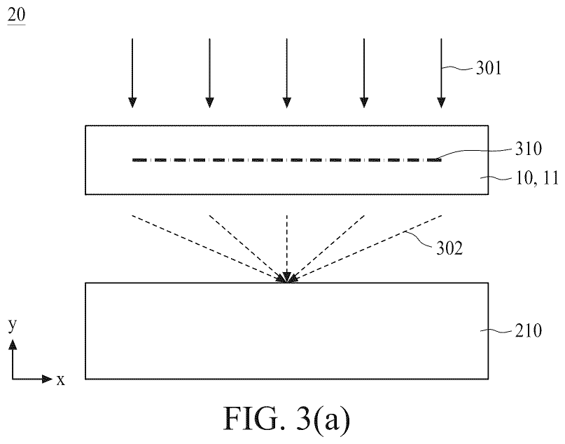

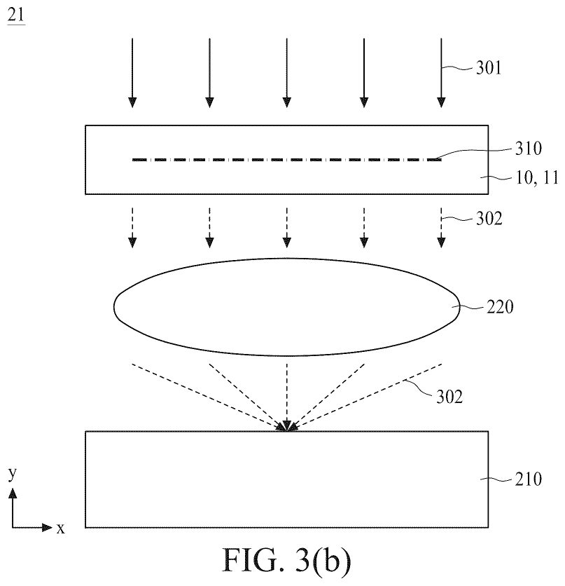

The present disclosure further provides an EUV or SXR beam profiler comprising the scintillator 10, 11. FIG. 3(a) illustrates a cross-sectional view of a beam profiler 20 according to an embodiment of the present disclosure. The beam profiler 20 includes the scintillator 10, 11 and an imaging system 210 configured to capture a fluorescence image 310 generated by the scintillator 10, 11.

The imaging system 210 may be optically coupled to the scintillator 10, 11. The imaging system 210 may contact the scintillator 10, 11. The imaging system 210 may contact the substrate 100. The imaging system 210 may contact the FOP. The imaging system 210 may contact the optical fibers of FOP. The imaging system 210 may not contact the scintillator 10, 11. The imaging system 210 may be configured to capture the radiation 302. The fluorescence image 310 may be generated by the scintillator layer 110 of the scintillator 10, 11. The scintillator 10, 11 may be disposed at a focal point of the imaging system 210. The scintillator layer 110 may be disposed at a focal point of the imaging system 210. The imaging system 210 is not particularly limited. Any imaging system suitable for capturing wavelengths in the range of 400 to 700 nm may be used. For example, the imaging system may be a CCD camera, CMOS camera, photodiode, photonic multichannel analyzer, hyperspectral imaging system, or multispectral imaging system.

In some embodiments, the radiation 301 may be present in a vacuum. The radiation 302 may be present at ambient pressure. The scintillator 10, 11 may be air-tight scaled to prevent gas leakage from ambient to vacuum. The scintillator layer 110 may be air-tight sealed to prevent gas leakage from ambient to vacuum. The substrate 100 may be air-tight sealed to prevent gas leakage from ambient to vacuum. The scintillator 10, 11 may be embedded in a metallic holder to create an air-tight seal. The metal holder may be mounted on a high-vacuum flange viewport through an O-ring to create an air-tight seal.

The beam profiler 20 may exhibit a linear response over a photon flux range less than about 2×10¹¹ photons/s. The beam profiler 20 may linearly convert the intensity of the radiation 301 into the intensity of the radiation 302 over a photon flux range less than about 2×10¹¹ photons/s. For example, the photon flux may be about 10, 10², 10³, 10⁴, 10⁵, 10⁶, 10⁷, 10⁸, 5×10⁸, 10⁹, 5×10⁹, 10¹⁰, 2×10¹⁰, 4×10¹⁰, 5×10¹⁰, 6×10¹⁰, 8×10¹⁰, 10¹¹, or 2×10¹¹ photons/s. The upper limit of the photon flux range may be any of the aforementioned values. A suitable photon flux range may be formed from any two of the aforementioned values.

The beam profiler 20 may have a spatial resolution less than about 50 μm, measured according to a standard knife-edge method. For example, the spatial resolution may be about 1, 5, 10, 15, 20, 25, 30, 35, 40, 45, or 50 μm. The upper limit of the spatial resolution range may be any of the aforementioned values. A suitable spatial resolution range may be formed from any two of the aforementioned values.

The beam profiler 20 may have an exposure time less than about 5 seconds. For example, the exposure time may be about 0.5 μs, 0.7 μs, 1 μs, 2 μs, 5 μs, 7 μs, 10 μs, 25 μs, 50 μs, 75 μs, 100 μs, 250 μs, 500 μs, 750 μs, 1 ms, 2 ms, 5 ms, 7 ms, 10 ms, 25 ms, 50 ms, 75 ms, 100 ms, 250 ms, 500 ms, 750 ms, 1 s, 2 s, or 5 s. The upper limit of the exposure time range may be any of the aforementioned values. A suitable exposure time range may be formed from any two of the aforementioned values.

The beam profiler 20 may have a signal-to-noise ratio greater than or equal to about 100, operated at an exposure time of 20 ms. For example, the signal-to-noise ratio may be about 100, 120, 140, 150, 160, 180, 200, 220, 240, 250, 260, 280, or 300. The lower limit of the range of noise-equivalent power density may be any of the aforementioned values. A suitable range of noise-equivalent power density may be formed from any two of the aforementioned values.

The beam profiler 20 may have a noise-equivalent power density at the radiation 301 being of 13.5 nm (or 91.8 eV) less than about 50 μW/cm²Hz^{1/2}. Preferably, the beam profiler 20 using FOP as the substrate 110 may have a noise-equivalent power density at the radiation 301 being of 13.5 nm (or 91.8 eV) less than about 1 μW/cm²Hz^{1/2}. For example, the noise-equivalent power density at 13.5 nm may be about 0.1, 0.2, 0.3, 0.4, 0.5, 0.6, 0.7, 0.8, 0.9, 1, 5, 10, 15, 20, 25, 30, 35, 40, 45, or 50 μW/cm²Hz^{1/2}. The upper limit of the range of noise-equivalent power density may be any of the aforementioned values. A suitable range of noise-equivalent power density may be formed from any two of the aforementioned values.

FIG. 3(b) illustrates a cross-sectional view of a beam profiler 21 according to an embodiment of the present disclosure. The beam profiler 21 is substantially the same as the beam profiler 20, except that the beam profiler 21 additionally includes a lens system 220 between the scintillator 10, 11 and the imaging system 210. The lens system 220 may be optically coupled to the scintillator 10, 11. The lens system 220 may be optically coupled to the imaging system 210.

The lens system 220 may provide an image magnification factor greater than 1 for the fluorescence image 310 to the imaging system 210. For example, the image magnification factor may be 1.01, 1.02, 1.03, 1.04, 1.05, 1.1, 1.2, 1.4, 1.5, 1.6, 1.8, 2, 2.2, 2.4, 2.5, 2.6, 2.8, or 3. A suitable range of the image magnification factor may be formed from any two of the aforementioned values.

The lens system 220 may include one, two, or more lenses. In some embodiments, the lens system 220 includes a first lens with a first focal length of 25.4 mm and a second lens with a second focal length of 35.1 mm, providing an image magnification factor of 1.4.

### Example 1: Preparation of Scintillator

Synthetic type-Ib diamond powders (Micron+MDA, Element Six) were converted to FNVD particles by bombardment with 10 MeV electrons, vacuum annealing at 800° C., and air oxidation at 450° C., as described in Lu et al., “Far-UV-Excited Luminescence of Nitrogen-Vacancy Centers: Evidence for Diamonds in Space,” Angew. Chem. Int. Ed. 2017, 56, 14469-14473. The average NV density in the FNVDs was about 10 ppm.

A FNVD layer on an ITO-coated glass substrate was prepared by electrospray deposition, as illustrated in FIG. 2. Specifically, FNVD particles were first dispersed in a 70:30 methanol/water solution at a concentration of 1 mg/mL. The FNVD suspension was then placed in a 1 mL glass syringe (Gastight Syringe 1001RN, Hamilton) equipped with a 2 cm long needle. The needle was positioned approximately 10 mm from the ITO-coated glass substrate (Uni-onward, Taiwan) mounted on a digital rotator (MX-RD-Pro, DLAB).

The syringe pump was operated at a flow rate of 180 μL/h, and the ITO-coated glass substrate was rotated at 10 rpm during the sample preparation. A high DC voltage of +4 kV was applied to the needle, while the ITO-coated glass substrate was grounded through its holder. A green laser beam was directed through the plume to monitor the spray's stability and ensure smooth deposition of the mist-like charged droplets onto the ITO-coated glass substrate. A FNVD layer with a thickness of about 1 μm was formed on the ITO-coated glass substrate.

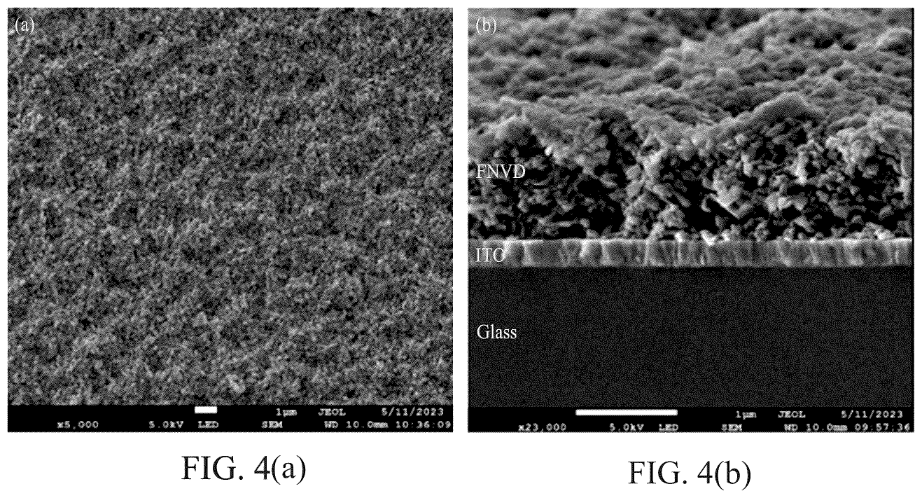

The as-prepared scintillator was subsequently heat-treated in an oven at 300° C. for 1 hour to remove residual water before use. FIGS. 4(a) and 4(b) show SEM images of a FNVD layer deposited on the ITO-coated glass substrate for 40 min in plan view and cross-sectional view, respectively. The FNVD layer reveals a polycrystalline structure. The FNVD layer has a thickness of about 1 μm, a density of about 1.7 g/cm³, and Rₐ of about 100 nm.

### Example 2: Assembly of Lens Coupled Beam Profiler

A lens coupled beam profiler was prepared by coupling the scintillator, operated in transmission mode, prepared in Example 1 with a lens system and an imaging system.

The lens system in the beam profiler consisted of two Ø 1″ lenses with focal lengths of 25.4 mm and 35.1 mm, respectively, providing an image magnification factor of 1.4. A visible CMOS camera with a sensing area of 4.97 mm×3.73 mm and a pixel size of 3.45 μm×3.45 μm was used to acquire the fluorescence image generated by the scintillator.

### The Assembly Process Involved the Following Steps:

1. Beam Monitoring Configuration: The scintillator of Example 1, supported by the PET film, was configured to operate in transmission mode for EUV or SXR beam profiling.
2. Mounting the Scintillator: The scintillator was mounted in a Ø 1″ lens tube.
3. Lens System Setup: Two Ø 1″ lenses with focal lengths of 25.4 mm and 35.1 mm were positioned to provide an image magnification factor of 1.4.
4. CMOS Camera Integration: A visible CMOS camera with a sensing area of 4.97 mm×3.73 mm and a pixel size of 3.45 μm×3.45 μm was integrated into the system to capture the fluorescence images generated by the scintillator.

The resulting lens coupled beam profiler provided a highly effective tool for EUV or SXR radiation beam profiling, enabling precise beam diagnostics and monitoring.

### Example 3: Assembly of Fiber Coupled Beam Profiler

In this example, the ITO-coated glass substrate in Example 1 is replaced with an ITO-coated FOP, and the lens system in Example 2 is omitted. Specifically, the surface of an FOP (3 mm thick) was first made electrically conductive by coating it with a thin layer (about 100 nm thick) of ITO using magnetron sputtering. The coating was readily applied to a FOP, which is made of glass and comprised of a bundle of micron-sized optical fibers. Electrospray deposition of FNVDs on the ITO-coated FOP was then performed according to the procedures described in Example 1.

The FOP has a numerical aperture of 1 and a resolving power of 6 μm. The fibers in the plate are fused to form a vacuum-tight glass plate and can be used as a zero-thickness window. Leveraging these properties, the FNVD-coated FOP was attached directly to the imaging sensor of a CMOS color camera, rendering it EUV or SXR-responsive and functional in a vacuum. This was accomplished by gluing the FNVD-coated FOP plate onto an aluminum holder to create an air-tight metal/glass seal and then mounting it on a high-vacuum 2.75″ CF flange viewport through an O-ring. On the air side, the FOP was connected in direct contact with a board-level CMOS module (sensing area of 4.97 mm×3.73 mm and a pixel size of 3.45 μm×3.45 μm), forming a highly compact fiber-coupled beam profiler system. The design allowed the images produced on the FNVD layer inside the vacuum chamber to be transported to the external surface without losing light. The image distortion percentage is about 1%, according to the specification.

### The Assembly Process Involved the Following Steps:

1. Preparation of Scintillator: The surface of the FOP was made electrically conductive by coating it with a thin layer (about 100 nm thick) of ITO using magnetron sputtering. Electrospray deposition of FNVDs on the ITO-coated FOP was performed to form a FNVD layer as described in Example 1.
2. Mounting the Scintillator: The scintillator was glued onto an aluminum holder to create an air-tight metal/glass seal and then mounted on a high-vacuum 2.75″ CF flange viewport through an O-ring.
3. CMOS Camera Integration: On the air side, the scintillator contacted a board-level CMOS module (sensing area of 4.97 mm×3.73 mm and a pixel size of 3.45 μm×3.45 μm), forming a highly compact fiber-coupled beam profiler.

The resulting fiber-coupled beam profiler provided a highly effective tool for EUV to SXR radiation beam profiling, enabling precise beam diagnostics and monitoring with minimal image distortion.

### Example 4: Beam Profiling Using Lens Coupled Beam Profiler

In this example, the lens coupled beam profiler prepared in Example 2 was used to characterize the beam profiles from two beamlines (BL03A1 and BL21B2) at Taiwan's National Synchrotron Radiation Research Center (NSRRC). These two beamlines have markedly different characteristics. The radiation in the BL03A1 beamline was generated from electrons passing through a bending magnet, whereas the radiation in the BL21B2 beamline was generated from electrons traversing a linear undulator.

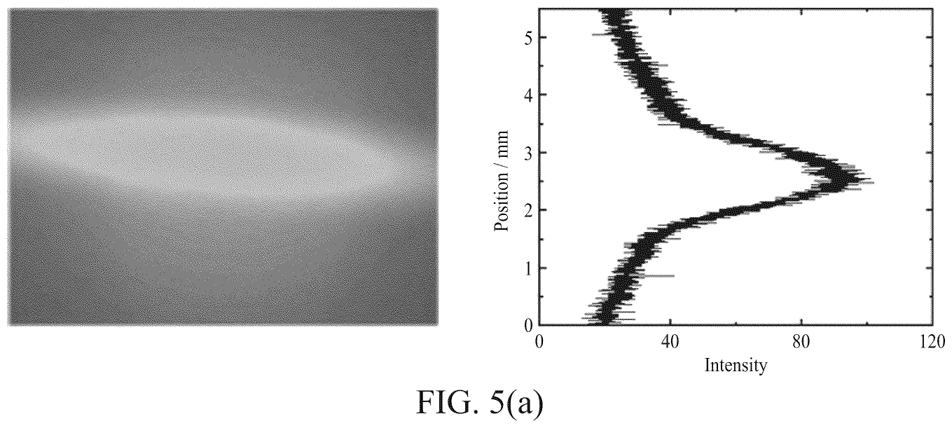

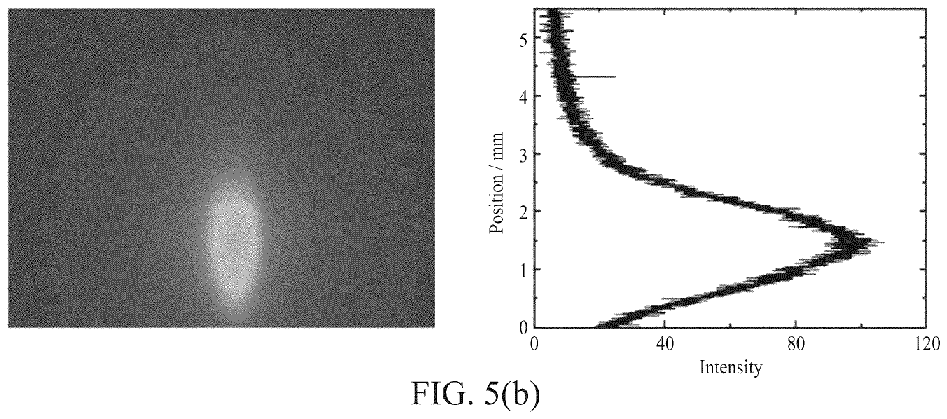

The fluorescence images of the 50 nm radiations from these two beamlines were obtained using the lens coupled beam profiler. FIG. 5(a) shows the fluorescence image and an intensity line profile in the vertical direction of the 50 nm radiation in the BL03A1 bending-magnet beamline. Widths of the slits are WS1=300 μm and WS2=500 μm. FIG. 5(b) shows the fluorescence image and an intensity line profile in the vertical direction of the 50 nm radiation in the BL21B2 undulator beamline. Widths of the slits are WS1=200 μm and WS2=400 μm. Image sizes on the screens in FIGS. 5(a) and 5(b) are 7.4 mm×5.55 mm.

The spatial resolution of the imager was measured using a standard knife-edge method in the BL21B2 beamline. The result confirms a spatial resolution of about 30 μm of this beam profiler.

The signal-to-noise ratio was determined as about 208 when the CMOS camera was operated at an exposure time of 20 ms, which suggests a noise equivalent power density of 29 μW/(cm² Hz^{1/2}) for the 13.5 nm radiation from the BL21B2 beamline.

In an actual EUV scanner (such as that produced by ASML), the power density of the beam is typically at the level of a few W/cm². Under this illumination condition, the exposure time of the beam profiler to the radiation in EUV lithographic applications could be substantially reduced to less than 10 μs, allowing for real-time monitoring and optimization of the microchip fabrication processes.

### Example 5: Beam Profiling Using Fiber Coupled Beam Profiler

In this example, the fiber coupled beam profiler prepared in Example 3 was used as a beam diagnostic tool for EUV or SXR radiation using the BL08B beamline at NSRRC, Taiwan. The beamline was equipped with two concave diffraction gratings, each having a ruling density of 350 or 1000 lines/mm, to disperse the EUV or SXR radiations over the wavelength range of 15.5-0.89 nm or the energy range of 80-1400 eV.

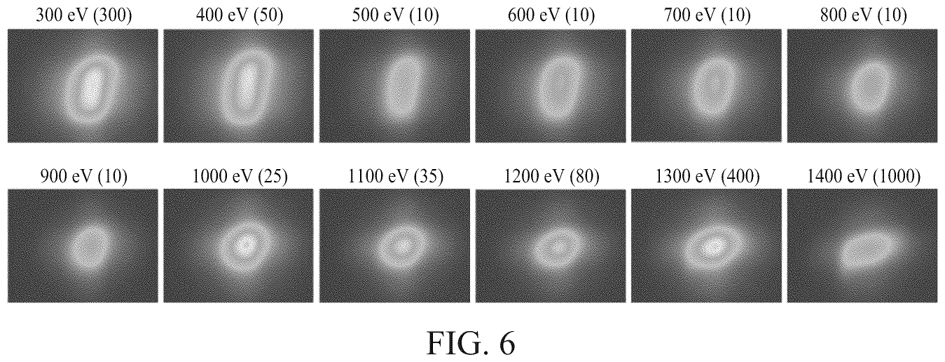

FIG. 6 shows the variation of the beam shape with the photon energy of the synchrotron radiations over 300-1400 eV. Numbers in parentheses are exposure times in the units of ms. The sensing area of the CMOS camera was 4.97 mm×3.73 mm.

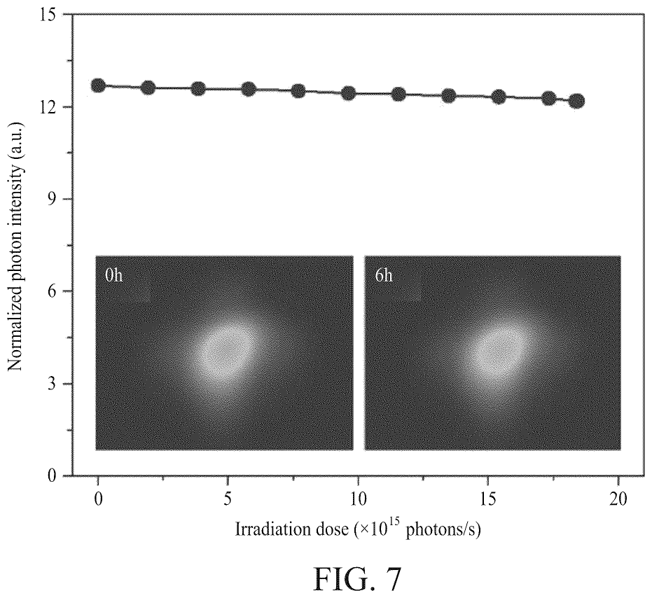

FIG. 7 shows the photostability test result of the beam profiler using 13.5 nm radiation from the BL08B beamline at an intensity of 24 μW/mm² for more than 6 hours. The beam flux used was 7.7×10¹¹ photons/s with a beam spot area of about 0.46 mm². The measured fluorescence intensities were normalized by the photocurrents of a calibrated photodiode. The images in FIG. 7 reveal the beam at the beginning (left) and end (right) of the measurements, showing a negligible change in beam profile after continuous operation for 6 hours. The fluorescence intensity decreased to approximately 4% of its initial value after 6 hours of continuous illumination of the FNVD film.

### Example 6: Light Yield Measurement of Scintillator

A lens coupled beam profiler with a photodiode as the imaging system was used to characterize a scintillator made from FNVDs with an average NV density of about 0.3 ppm. The scintillator with an average NV density of about 0.3 ppm was prepared according to the process described in Example 1. The lens coupled beam profiler with a photodiode as the imaging system was assembled according to the process described in Example 2.

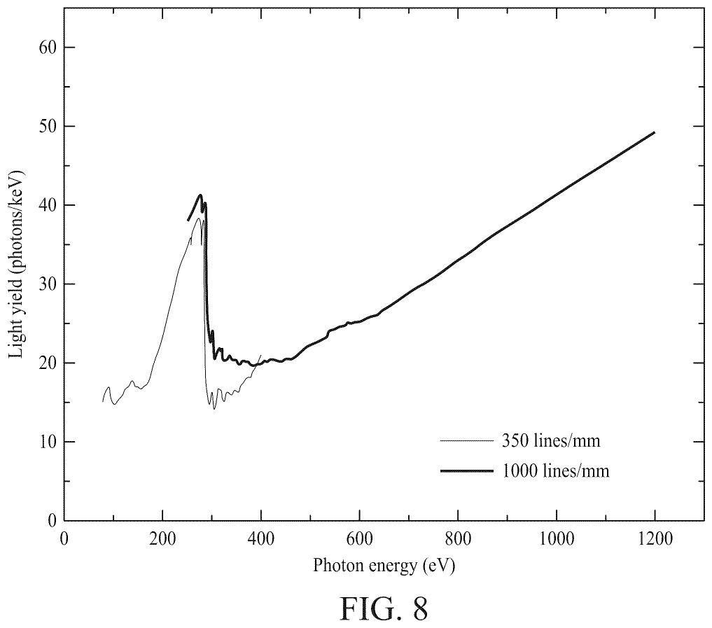

Light yield measurements were performed using synchrotron radiation from beamline BL21B8, which is equipped with two concave diffraction gratings, each having a ruling density of 350 or 1000 lines/mm. The beamline BL21B8 had a bending-magnet source and provided a beam flux on the order of 10¹¹-1013 photons/s over the energy range of 80-1200 eV. An absolute extreme ultraviolet photodiode (AXUV100G, Opto Diode) measured the photon fluxes of the incident beam at the position of the scintillator. A photodiode (PIN-10D, OSI Optoelectronics) was used for detecting the total fluorescence emitted from the scintillator. FIG. 8 shows the light yields of the scintillator for EUV/SXR radiations over the 80-1200 eV energy range. The abrupt changes at 285 eV are due to the K-edge absorption of carbon atoms. Specific light yield is 49 photons/keV (at incident beam energy of 1200 eV), 33 photons/keV (at incident beam energy of 800 eV), or 17 photons/keV (at incident beam energy of 90 eV).

In summary, the use of FNVD film as a scintillator, the incorporation of FNVD-coated FOPs in the EUV detector, and the adaptation of electrospray deposition for applying FNVD film provide substantial improvements in sensitivity, resolution, durability, and overall performance compared to prior art methods and detectors. These advantages make the EUV detector comprising FNVD film an ideal solution for advanced imaging and detection applications in the field of EUV and SXR radiations.

### The Present Disclosure May Provide the Following Embodiments:

1. A beam profiler, comprising:
   a scintillator; and
   an imaging system configured to capture a fluorescence image generated by the scintillator;
   the scintillator comprising:
      a substrate; and
      a scintillator layer over the substrate,
   wherein the scintillator layer comprises one or more fluorescent nitrogen-vacancy diamonds and has a density of about 1 to 3.5 g/cm³.
2. The beam profiler according to item 1, wherein the scintillator comprises one or more nitrogen-vacancy centers with an average density ranging from about 0.1 to 1,000 parts per million.
3. The beam profiler according to item 1, wherein the scintillator is disposed at a focal point of the imaging system.
4. The beam profiler according to item 1, further comprising a lens system optically coupled to the scintillator.
5. The beam profiler according to item 4, wherein the lens system comprises two or more lenses.
6. The beam profiler according to item 5, wherein the lens system provides an image magnification factor greater than 1 for a fluorescence image generated by the scintillator layer to the imaging system.
7. A beam profiler, comprising:
   a scintillator; and
   an imaging system contacting the scintillator;
   the scintillator comprising:
      a fiber optic plate;
      an electrically conductive layer over the fiber optic plate; and
      a scintillator layer over the electrically conductive layer,
   wherein the scintillator layer comprises one or more fluorescent nitrogen-vacancy diamonds and has a length of 1 to 100 mm in the direction substantially parallel to an interface between the electrically conductive layer and the fiber optic plate.
8. The beam profiler according to item 7, wherein the fiber optic plate comprises one or more optical fibers extending along the direction substantially perpendicular to the interface.
9. The beam profiler according to item 8, wherein one or more ends of the one or more optical fibers contact the electrically conductive layer.
10. The beam profiler according to item 7, wherein the fiber optic plate has a numerical aperture of about 0.5 to 2.
11. The beam profiler according to item 7, wherein the fiber optic plate has a resolving power of about 2 to 10 μm.
12. The beam profiler according to item 7, wherein the beam profiler has a spatial resolution less than about 50 μm.
13. The beam profiler according to item 7, wherein the beam profiler has a signal-to-noise ratio greater than or equal to about 100.
14. A scintillator, comprising:
   a substrate; and
   a scintillator layer over the substrate,
   wherein the scintillator layer comprises one or more fluorescent nitrogen-vacancy diamonds and has a density of about 1 to 3.5 g/cm³.
15. The scintillator according to item 14, further comprising an electrically conductive layer disposed between the substrate and the scintillator layer.
16. The scintillator according to item 14, wherein the scintillator layer has a thickness ranging from about 0.1 to 500 μm.
17. The scintillator according to item 16, wherein the scintillator layer has an average surface roughness Rₐ of less than about 1,000 nm.
18. The scintillator according to item 17, wherein the one or more fluorescent nitrogen-vacancy diamonds comprise nitrogen-vacancy centers with a density of about 0.1 to 1,000 ppm.
19. The scintillator according to item 17, wherein the one or more fluorescent nitrogen-vacancy diamonds comprise neutral nitrogen-vacancy centers with a density of about 0.1 to 1,000 ppm.
20. The scintillator according to item 14, wherein the scintillator layer has a light yield of greater than or equal to 10 photons/keV at an energy of incident radiation ranging from about 10 to 1500 eV.
21. A method for forming a scintillator, comprising:
   providing a substrate;
   dispersing fluorescent nitrogen-vacancy diamond particles in a solvent to form a dispersion;
   producing charged droplets comprising the fluorescent nitrogen-vacancy diamond particles from the dispersion; and
   depositing the charged droplets over the substrate.
22. The method according to item 21, further comprising providing the dispersion in an injector.
23. The method according to item 22, further comprising applying an electrical field between the injector and the substrate.
24. The method according to item 21, wherein the fluorescent nitrogen-vacancy diamond particles have a mean hydrodynamic diameter of about 50 to 200 nm.
25. The method according to item 21, wherein the fluorescent nitrogen-vacancy diamond particles have a polydispersity index of about 0.05 to 0.2.
26. The method according to item 21, wherein the fluorescent nitrogen-vacancy diamond particles comprise nitrogen-vacancy centers with a density of about 0.1 to 1,000 ppm.
27. The method according to item 21, wherein the fluorescent nitrogen-vacancy diamond particles comprise neutral nitrogen-vacancy centers with a density of about 0.1 to 1,000 ppm.

The foregoing description of the present disclosure has been provided for the purposes of illustration and description. It is not intended to be exhaustive or to limit the present disclosure to the precise forms disclosed. Many modifications and variations will be apparent to the practitioner skilled in the art.

The embodiments were chosen and described in order to best explain the principles of the present disclosure and its practical application, thereby enabling others skilled in the art to understand the present disclosure for various embodiments and with various modifications that are suited to the particular use contemplated.

As used herein and not otherwise defined, the terms “substantially,” “substantial,” “approximately” and “about” are used to describe and account for small variations. When used in conjunction with an event or circumstance, the terms can encompass instances in which the event or circumstance occurs precisely as well as instances in which the event or circumstance occurs to a close approximation. For example, when used in conjunction with a numerical value, the terms can encompass a range of variation of less than or equal to ±10% of that numerical value, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%. The term “substantially coplanar” can refer to two surfaces within micrometers of lying along a same plane, such as within 40 within 20 within 10 or within 1 μm of lying along the same plane.

As used herein, the singular terms “a,” “an,” and “the” may include plural referents unless the context clearly dictates otherwise. In the description of some embodiments, a component provided “on” or “over” another component can encompass cases where the former component is directly on (e.g., in physical contact with) the latter component, as well as cases where one or more intervening components are located between the former component and the latter component.

While the present disclosure has been described and illustrated with reference to specific embodiments thereof, these descriptions and illustrations are not limiting. It should be understood by those skilled in the art that various changes may be made and equivalents may be substituted without departing from the true spirit and scope of the present disclosure as defined by the appended claims. The illustrations may not necessarily be drawn to scale. There may be distinctions between the artistic renditions in the present disclosure and the actual apparatus due to manufacturing processes and tolerances. There may be other embodiments of the present disclosure which are not specifically illustrated. The specification and the drawings are to be regarded as illustrative rather than restrictive. Modifications may be made to adapt a particular situation, material, composition of matter, method, or process to the objective, spirit and scope of the present disclosure. All such modifications are intended to be within the scope of the claims appended hereto. While the methods disclosed herein have been described with reference to particular operations performed in a particular order, it will be understood that these operations may be combined, sub-divided, or re-ordered to form an equivalent method without departing from the teachings of the present disclosure. Accordingly, unless specifically indicated herein, the order and grouping of the operations are not limitations.

What is claimed is:

1. A beam profiler, comprising:
a scintillator; and
an imaging system configured to capture a fluorescence image generated by the scintillator;
the scintillator comprising:
a substrate; and
a scintillator layer over the substrate,
wherein the scintillator layer comprises one or more fluorescent nitrogen-vacancy diamonds and has a density of about 1 to 3.5 g/cm³.

2. The beam profiler according to claim 1, wherein the scintillator comprises one or more nitrogen-vacancy centers with an average density ranging from about 0.1 to 1,000 parts per million.

3. The beam profiler according to claim 1, wherein the scintillator is disposed at a focal point of the imaging system.

4. The beam profiler according to claim 1, further comprising a lens system optically coupled to the scintillator.

5. The beam profiler according to claim 4, wherein the lens system comprises two or more lenses.

6. The beam profiler according to claim 5, wherein the lens system provides an image magnification factor greater than 1 for a fluorescence image generated by the scintillator layer to the imaging system.

7. A beam profiler, comprising:
a scintillator; and
an imaging system contacting the scintillator;
the scintillator comprising:
a fiber optic plate;
an electrically conductive layer over the fiber optic plate; and
a scintillator layer over the electrically conductive layer,
wherein the scintillator layer comprises one or more fluorescent nitrogen-vacancy diamonds and has a length of 1 to 100 mm in the direction substantially parallel to an interface between the electrically conductive layer and the fiber optic plate.

8. The beam profiler according to claim 7, wherein the fiber optic plate comprises one or more optical fibers extending along the direction substantially perpendicular to the interface.

9. The beam profiler according to claim 8, wherein one or more ends of the one or more optical fibers contact the electrically conductive layer.

10. The beam profiler according to claim 7, wherein the fiber optic plate has a numerical aperture of about 0.5 to 2.

11. The beam profiler according to claim 7, wherein the fiber optic plate has a resolving power of about 2 to 10 μm.

12. The beam profiler according to claim 7, wherein the beam profiler has a spatial resolution less than about 50 μm.

13. The beam profiler according to claim 7, wherein the beam profiler has a signal-to-noise ratio greater than or equal to about 100.

14. A method for forming a scintillator, comprising:
providing a substrate;
dispersing fluorescent nitrogen-vacancy diamond particles in a solvent to form a dispersion;
producing charged droplets comprising the fluorescent nitrogen-vacancy diamond particles from the dispersion; and
depositing the charged droplets over the substrate.

15. The method according to claim 14, further comprising providing the dispersion in an injector.

16. The method according to claim 15, further comprising applying an electrical field between the injector and the substrate.

17. The method according to claim 14, wherein the fluorescent nitrogen-vacancy diamond particles have a mean hydrodynamic diameter of about 50 to 200 nm.

18. The method according to claim 14, wherein the fluorescent nitrogen-vacancy diamond particles have a polydispersity index of about 0.05 to 0.2.

19. The method according to claim 14, wherein the fluorescent nitrogen-vacancy diamond particles comprise nitrogen-vacancy centers with a density of about 0.1 to 1,000 ppm.

20. The method according to claim 14, wherein the fluorescent nitrogen-vacancy diamond particles comprise neutral nitrogen-vacancy centers with a density of about 0.1 to 1,000 ppm.
